(19) United States
(12) Patent Application Publication
(10) Pub. No.: US 2006/0107818 A1
(43) Pub. Date: May 25, 2006

(54) Apparatus for dampening impact vibration in manual tools

(76) Inventor: Brian Judd, Campbell, CA (US)

Correspondence Address: BAY AREA INTELLECTUAL PROPERTY GROUP, LLC, PO BOX 210459, SAN FRANCISCO, CA, 94121-0459, US

(21) Appl. No.: 10/996,747

(22) Filed: Nov. 24, 2004

(51) Int. Cl. G10D 13/02

(52) U.S. Cl. 84/422.4

(57) ABSTRACT

A device is provided for dampening the impact vibration of elongated manual tools that have a handle, such as drumsticks and hammers. The device includes means for dampening the vibration caused when striking tool onto a hard surface, and means for removably joining the dampening means to the end of the tool's handle. Some embodiments further include means for standing off the dampening means from being fully applied onto the end of the tool's handle. In many applications, embodiments of the present dampening device help reduce fatigue and injury due to impact vibrations being transmitting to the user.

### CROSS-REFERENCE TO RELATED APPLICATIONS

The present Utility patent application claims priority to the provisional application for patent having the application number of 60/525,446 and was filed on Nov. 26, 2003.

### FIELD OF THE INVENTION

The present invention relates generally to dampening impact vibration in manual tools. More particularly, the invention relates to dampening impact vibration in manual tools having an elongated rigid shaft where the vibration is transmitted from the impacted end of the shaft into the hand of the user holding and forcing the shaft.

### BACKGROUND OF THE INVENTION

One typical application where a user strikes an elongated rigid shaft onto a rigid surface is that of drumsticks. Drummers traditionally use wooden drumsticks, however, although by far not as popular, there are others made of metal and plastic.

Drumsticks are held in a few standard positions, one common position is hold by hand the drumstick about ⅓ of the way from what is referred to as the butt end. The drummer will typically pivot the drumstick at the holding point and strike a drum with the striking end of the drumstick.

It is a well know problem that when the striking end of the drumstick impacts the drum surface there is vibration energy that is transmitted from the point of impact into the shaft of the drumstick and thereby into the users hand, wrist, and tendons, which is known to cause fatigue, tendonitis, what is referred to as drummer's elbow, and other related problems.

Attempts have been made to reduce the vibration transferred to a drum player's hand. Some known techniques drill out a cylindrical hole in the butt end of the drumstick, and fill the volume with a relatively more dense and compliant material than that of the drumstick (e.g., by inserting rubber). Although such approaches do tend to reduce the vibration transferred into the player's hand by reducing the vibration of the drumstick, several very undesirably problems result from this approach. For example, because the butt of the stick is hollowed out, its structural integrity is compromised and it has a much greater tendency to break during use, especially when the player uses the butt end to strike the drum. Another exemplary problem is that players usually do not want to purchase a special kind of drumstick so modified, which are often more costly due to the higher manufacturing cost, or similarly modify their own drumstick. Moreover, many players dislike such conventional approaches as the overall “feel” of the drumstick is changed (e.g., a new center of mass), which feel is often an important factor in optimal playing performance. Significant retraining by the musician is typically required to adapt to a new drumstick feel.

Other known techniques attempt to isolate the drumstick from the hand by way of a compliant sleeve, or handgrip, on the gripping location of the drumstick. Although such approaches do tend to reduce the vibration transferred into the player's hand by reducing the vibration of the drumstick, they also unfortunately drastically alter the feel of the drumstick to the play, which is very undesirable to most trained musicians. Musicians are typically trained to a certain size of drumstick to achieve a certain sound during play. For example, the addition of a handgrip significantly changes the drumstick's weight distribution and increases the diameter at the holding location of the drumstick and often requires the musicians to retrain themselves to attain the same level of performance, as they normally would have without using the handgrips.

Similar impact vibration problems exist in many other applications, which have an elongated shaft that is held by a person who is striking a hard surface therewith. Hammer applications are one example, where a very similar profile of causality and usage problems exist in the context of the foregoing drumstick application. It is well known that upon striking a hammer on a rigid surface that after the impact there are residual vibrations that transfer into the persons wrist and elbow to cause discomfort and, over time, pain or injury. Some conventional attempts to reduce impact vibration to the user have been mainly focused on the selection of shaft, or handle, material or grip thereof, including shafts made from wood and fiberglass and the molding of rubber handle grips.

Hence, it would be desirable for improved techniques of dampening impact vibrations in manual tools. It would be further desirable if such improved approaches were easily adapted to a preexisting tool without requiring modification thereof or substantially changing the tool's feel to the user.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side perspective view of a first embodiment directed to an exemplary drumstick dampening cap application;

FIG. 2 illustrates a side perspective view of an instance of the first embodiment mounted onto an exemplary drumstick;

FIG. 3a illustrates a side perspective view of a second embodiment directed to an exemplary hammer dampening cap application;

FIG. 3b illustrates a side perspective view of an exemplary hex shaped hammer dampening-cap in accordance with an embodiment of the present invention;

FIG. 4 illustrates a side perspective view of an instance of the second embodiment mounted onto an exemplary hammer;

FIG. 5 illustrates a side perspective, transparent view showing the internal structure of an exemplary boss standoff embodiment directed to a hammer application; and

FIG. 6 illustrates a rear perspective, transparent view showing the internal structure of an exemplary ring standoff embodiment directed to a hammer application.

Unless otherwise indicated illustrations in the figures are not necessarily drawn to scale.

### SUMMARY OF THE INVENTION

To achieve the forgoing and other objects and in accordance with the purpose of the invention, a variety of techniques for dampening the impact vibration in manual tools are described.

A device is provided for dampening the impact vibration of elongated manual tools that have a handle, such as drumsticks and hammers. The device includes means for dampening the vibration caused when striking tool onto a hard surface, and means for removably joining the dampening means to the end of the tool's handle. Some embodiments further include means for standing off the dampening means from being fully applied onto the end of the tool's handle.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. Similarly, detailed descriptions of preferred embodiments are provided herein. It is to be understood, however, that the present invention may be embodied in various forms beyond any preferred embodiments. Therefore, specific details disclosed herein are not to be interpreted as limiting, but rather as a basis for the claims and as a representative basis for teaching one skilled in the art to employ the present invention in virtually any appropriately detailed system, structure or manner.

The present invention is directed to dampening impact vibration in manual tools having an elongated rigid shaft where the vibration is transmitted from the impacted end of the shaft into the hand of the user holding and forcing the shaft of the tool. This dampening is preferably achieved by adapting the non-striking end of the manual tool with what is herein referred to as a dampening cap according to the teaching of the following detailed description and exemplary embodiments.

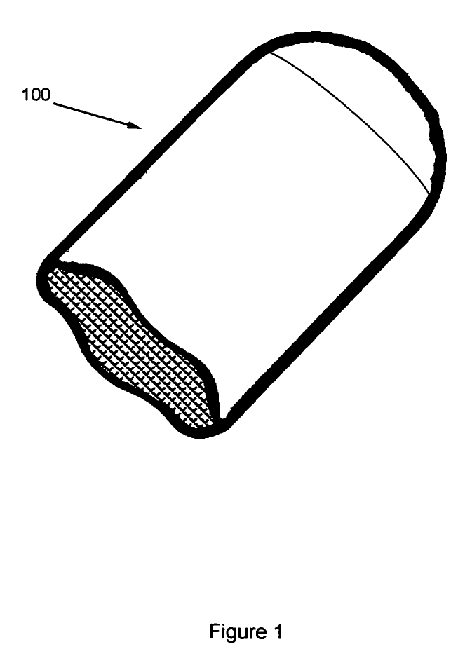

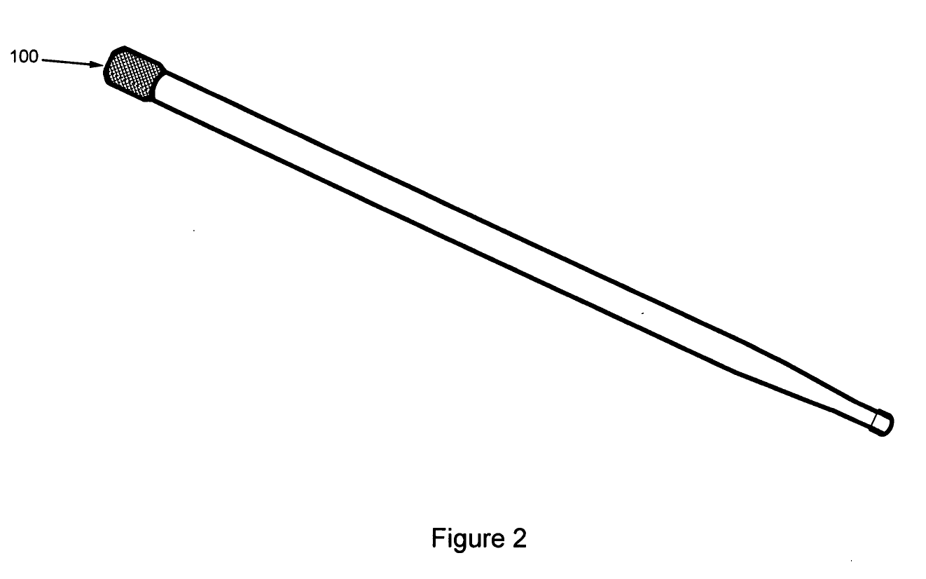

FIG. 1 illustrates a side perspective view of a first embodiment directed to an exemplary drumstick dampening cap application. Drumstick dampening cap 100 is designed to snuggly fit onto the end of a drumstick. Drumstick dampening cap 100 is preferably fabricated from a compliant material (e.g., relatively flexible, not stiff), including, but not limited to, thermoplastic elastomers (e.g. plastic moldable rubbers such as Santoprene or Krayton) and common rubber. The first embodiment may be formed into any suitable shape to properly fit onto the end of the desired type of drumstick. FIG. 2 illustrates a side perspective view of an instance of the first embodiment mounted onto an exemplary drumstick. The addition of the present drumstick dampening-cap to the outside of the drumstick's butt tends to dampen the internal vibration within the drumstick's shaft, and thereby reduce the vibrational energy transmitted to the player's hand. By way of example, and not limitation, a dampening cap, made of a stretchable material, for some drumstick application may be three quarters of an inch long and have a suitable diameter to stretch-fit onto the desired range of drumstick butt diameters. Moreover, in some applications, the more dissimilar the dampening cap material is from the drumstick cap the more improved the dampening effect.

One embodiment of the present invention is designed to stretch and fit over the butt of a drumstick. Such embodiments of the present drumstick dampening-cap are made of sufficiently stretchable materials that permit easy stretch fitting onto a wide range of drumsticks. That is, making the hammer dampening-cap of a suitably stretchable material that the stretch fit capability accommodates a relatively unrestricted range of hammer butt shapes and sizes, the, which is especially useful for hammers that often have a hex or odd shaped butt end. Compliant embodiments of the present invention may be manufactured according to known methods including but not limited to, injection molding and thermoforming.

An aspect of the present invention provides that in some applications, the present anti-vibration, dampening cap may be slid fully or partially onto the drumstick butt. The degree of dampening may be controlled by how complete the present anti-vibration, dampening cap (dampening cap) is fitted onto the drumstick butt. That is, when the drumstick is fully placed within the dampening cap a minimum level of dampening is achieved, and when the drumstick is attached at the open end of the present dampening cap, a maximum level of dampening is achieved. The material chose may also increase or decrease the amount of dampening achieved. For example, a more compliant material that is partially fitted on the butt of the drumstick will tend to oscillate back and forth with respect to the drumstick shat, thereby dissipating (i.e., dampening) additional vibrational energy beyond only the inertial dampening gain by virtue of adding mass to the drumstick. Users of the present dampening cap will readily be able to learn the appropriate positioning of the dampening cap onto the drumstick that achieves their desired level of vibration dampening.

Preferred embodiments of the present invention make the dampening cap out of a stretchable material that provides for the easy and convenience of stretch fitting the stretchable dampening cap over a wide range of drumstick butt diameters. Some alternate embodiments of the present invention may be formed only partially of stretchable materials at their butt receiving end so that they are only capable of partially stretch fitting onto the butt. Alternative means for joining a drumstick dampening-cap, according to the present invention, to the drumstick butt will be readily apparent to those skilled in the art.

Compliant embodiments of the present invention have a multiplicity of attendant aspects that provide additional utility to many musicians. By way of example, an aspect of dampening cap embodiments being made of a relatively soft material is that drum players may optionally and easily strike the drum with the dampening cap end of their drumstick to achieve a soft striking sound (e.g., a soft attack) when desired, thereby potentially expanding the range of sounds of drumstick adapted according to the present invention can achieve. The degree of attack may be controlled to some degree by properly selecting the proper durometer or stiffness of the foregoing described compliant material used. Typically, to achieve a soft attack, conventional drumsticks would require that a different drumstick with a felt tip be used, which requires additional skill to switch during play between drumsticks with different attacks.

In another aspect of the present invention, because the present dampening cap does not significantly alter the feel of the drumstick to the player; hence, no retraining is required to attain the same level of performance as without attaching the present dampening caps. In yet another aspect of the present invention, because the present dampening cap dampens at least a portion of the vibration that is transferred to a user's hand, fatigue and related injuries tend to be reduce, or completely eliminated. Moreover, by dampening energy away from the user's hand, a more solid and more powerful strike on the drum surface is typically possible.

Depending on the needs of the particular application, those skilled in the art will readily configure the physical dimensions, material, and surface texture of the present dampening cap in any suitable way in accordance with the teachings of the present invention. For example, alternative embodiments of the present invention may, instead of compliant, be made of relatively stiff, or even hard, materials. which are properly configured to according to the foregoing teachings.

The teachings of the present invention may be applied to similar impact vibration problems that exist in a multiplicity of other applications that have an elongated, rigid shaft that is held by a person who is striking a hard surface therewith.

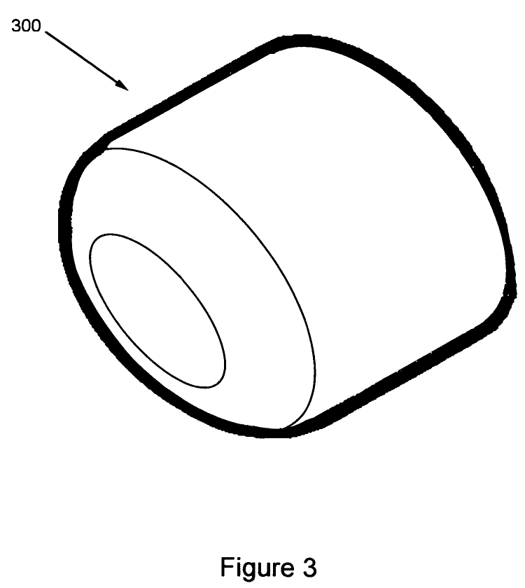

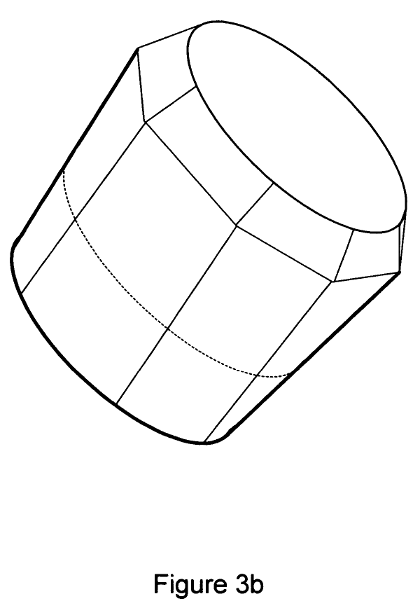

By way of example, and not limitation, a hammer is an exemplary application where the foregoing teachings may be suitably adapted to similarly dampen vibration transmitted to the user. The foregoing teachings of the drumstick embodiment of the present invention may be readily applied with minor changes to hammer dampening cap embodiments. FIG. 3a illustrates a side perspective view of a second embodiment directed to a hammer dampening cap application. A exemplary circular hammer dampening cap 300 is shown in the Figure. Those skilled in the art will recognize a multiplicity of alternative and suitable shapes of the hammer dampening-cap depending on the shape of the hammer butt or other application dependent factors. By way of example, and not limitation, FIG. 3b illustrates a side perspective view of an exemplary hex shaped hammer dampening-cap 350 in accordance with an alternate implementation of the second embodiment of the present invention, which is suitable to fit a hex and/or non-hex (e.g., circular, oblong, elliptical, etc.) shaped hammer butt.

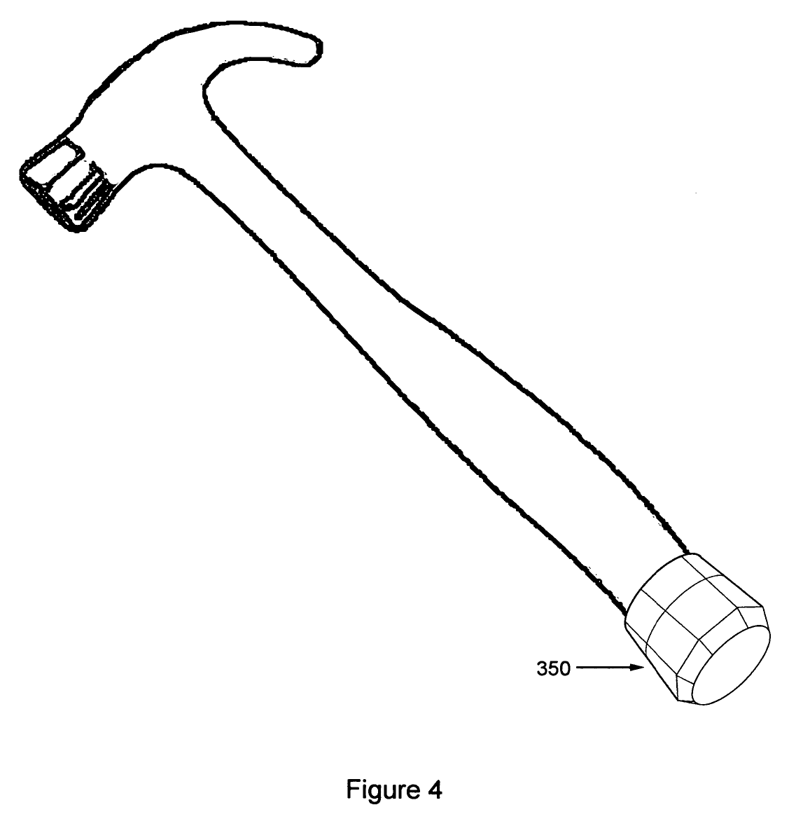

FIG. 4 illustrates a side perspective view of an instance of the second embodiment mounted onto an exemplary hammer. Hammer dampening-cap 350 is shown attached to the hammer's butt. Similar to the forgoing drumstick problem, when using hammer dampening-cap 350, hammer users (e.g., carpenters, mechanics, etc.) may be substantially protected from the severe vibration transferred to his or her hand, wrist, and forearm upon striking a hard surface with the hammer. The embodiment show is removable and may be added as an aftermarket impact vibration-dampening product to the consumer's hammer of choice.

In a preferred embodiment, the hammer dampening-cap is fabricated from a compliant material as described above. A compliant hammer dampening-cap properly fitted onto to the hammer's butt end will at least in part absorb and cancel out vibration in the hammer shaft after impact, thereby reducing, or eliminating, transfer to the user's hand, wrist, and forearm. Some embodiments use compliant materials that are to some degree stretchable, such that such a stretchable hammer dampening-cap can stretch fit on the end of the hammer. Alternate embodiments may be made of stiff or hard materials that may be press-fitted or even compliantly joined to the hammer. Alternative means for joining a hammer dampening-cap, according to the present invention, to the drumstick butt will be readily apparent to those skilled in the art.

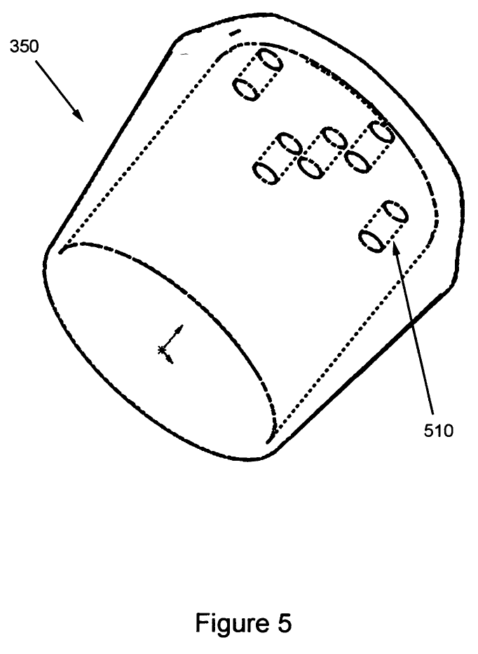

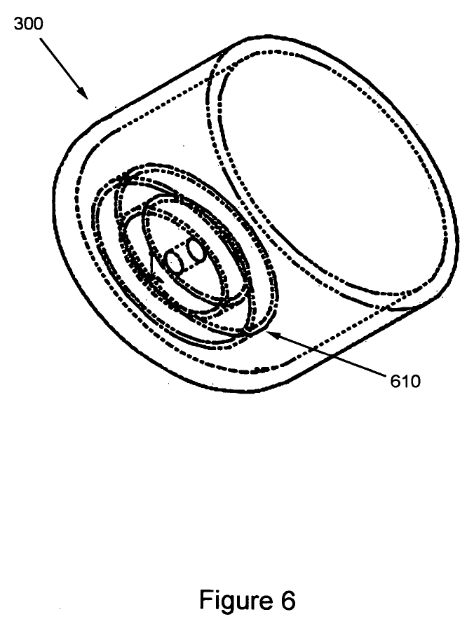

To assure that the dampening-cap cannot be fully put onto the hammer, any suitable standoff method may be implemented. FIG. 5 illustrates a side perspective, transparent view showing the internal structure of an exemplary boss standoff embodiment directed to a hammer application. As shown, one standoff approach is to include molded standoff bosses 510 to set a minimum clearance between the end of the hammer butt and roof of dampening-cap 300. Standoff bosses 510 protrude from and are disposed about the inside of the dampening-cap roof. By increasing the standoff distance, an increased vibration dampening effect of the dampening cap may be achieved in a similar manner as that described for the drumstick application. Another standoff embodiment implements protruding rings, instead of bosses. FIG. 6 illustrates a rear perspective, transparent view showing the internal structure of an exemplary ring standoff embodiment directed to a hammer application. Standoff rings 610 protrude from and are concentrically disposed upon the inside of the dampening-cap roof.

Those skilled in the will readily recognize a multiplicity of alternative and suitable means to limit the insertion of the dampening-cap onto the shaft, including, but not limited to, a ring stop along the upper side walls, etc. In some applications implementing compliant materials it is preferable use standoff means that also permit the dampening-cap to flex to some degree with respect to the hammer butt, which may help further dissipate vibration energy in the hammer's shaft. It should be appreciated that the foregoing standoff description with respect to a hammer, likewise applies with appropriate modification to the drumstick and other suitable applications.

Having fully described at least one embodiment of the present invention, other equivalent or alternative methods of dampening impact vibration in manual tools according to the present invention will be apparent to those skilled in the art. The invention has been described above by way of illustration, and the specific embodiments disclosed are not intended to limit the invention to the particular forms disclosed. For example, the particular implementation of the dampening-cap shown were directed to drumstick and hammer applications, however those skilled in the art will readily adapt the foregoing teachings to any dampening impact vibration in any suitable manual tool having an elongated rigid shaft, whereby such adapted implementations of the present invention are contemplated as within the scope of the present invention. The invention is thus to cover all modifications, equivalents, and alternatives falling within the spirit and scope of the following claims.

What is claimed is:

1. A device for dampening impact vibration in an elongated manual tool having a handle, the apparatus comprising:
means for dampening the impact vibration in the elongated manual tool; and
means for removably joining said dampening means to the end of the handle.

2. The vibration dampening device of claim 1, further comprising means for standing off said dampening means from being fully applied onto the end of the handle.

3. The vibration dampening device of claim 1, wherein the elongated manual tool is a drumstick.

4. The vibration dampening device of claim 3, wherein said dampening means is joined to the end of the drumstick handle.

5. The vibration dampening device of claim 1, wherein the elongated manual tool is a hammer.

6. The vibration dampening device of claim 5, wherein said dampening means is joined to the end of the hammer handle.

7. A device for dampening impact vibration in a hammer, the apparatus comprising:
means for dampening the impact vibration in the hammer; and
means for removably joining said dampening means to the end of the hammer handle.

8. The vibration dampening device of claim 7, further comprising means for standing off said dampening means from being fully applied onto the end of the hammer handle.

9. The vibration dampening device of claim 7, wherein said dampening means is joined to the end of the hammer handle.

10. A device for dampening impact vibration in a drumstick, the apparatus comprising:
means for dampening the impact vibration in the drumstick; and
means for removably joining said dampening means to the end of the drumstick handle.

11. The vibration dampening device of claim 10, further comprising means for standing off said dampening means from being fully applied onto the end of the drumstick handle.

12. The vibration dampening device of claim 10, wherein said dampening means is joined to the end of the drumstick handle.
